(19) United States
(12) Patent Application Publication
(10) Pub. No.: US 2025/0385626 A1
(43) Pub. Date: Dec. 18, 2025

(54) SEMICONDUCTOR DEVICE, MOTOR CONTROL SYSTEMS AND MOTOR CONTROL METHODS

(71) Applicant: Renesas Electronics Corporation, Tokyo (JP)

(72) Inventors: Takahiro HOSAKA, Tokyo (JP); Motoshige IKEDA, Tokyo (JP)

(21) Appl. No.: 19/173,976

(22) Filed: Apr. 9, 2025

(30) Foreign Application Priority Data
Jun. 14, 2024 (JP) 2024-096644

(51) Int. Cl. H02P 6/15; H02P 6/16

(52) U.S. Cl. CPC H02P 6/15; H02P 6/16

(57) ABSTRACT

In a method where a controller controls a motor via a semiconductor device, reduce power consumption while ensuring control accuracy. In the semiconductor device, the remaining step number control circuit obtains the first remaining step number by subtracting the number of steps that could be processed for FB (feedback) signal generation between the first CTE (carrier period event) and the next second CTE from the first next step number at the time of the first CTE occurrence. The total step number control circuit obtains the second total step number by adding the second next step number and the first remaining step number at the time of the second CTE occurrence. The output circuit generates the FB signal based on the second total step number.

### CROSS-REFERENCE TO RELATED APPLICATIONS

The disclosure of Japanese Patent Application No. 2024-096644 filed on Jun. 14, 2024, including the specification, drawings and abstract is incorporated herein by reference in its entirety.

### BACKGROUND

The present invention relates to a semiconductor device, a motor control system, and a motor control method.

There are disclosed techniques listed below.

### [Patent Document 1] Japanese Unexamined Patent Application Publication No. 2019-88185

One method of controlling a motor is known as where a controller controls the motor via a semiconductor device. An example of such a method is Patent Document 1.

### SUMMARY

In the method where a controller controls a motor via a semiconductor device, it is required to reduce power consumption while ensuring control accuracy.

A representative embodiment includes a semiconductor device comprising: a processor that generates and outputs a signal for controlling a motor based on instruction information input from an external controller, and generates and outputs rotation amount information of the motor based on rotation angle information input from the motor side; a timer circuit that generates random modulation carrier period event; and a feedback signal generation circuit that generates a feedback signal corresponding to the rotation angle of the motor based on the rotation amount information of the motor input from the processor and the carrier period event generated by the timer circuit, and outputs it to the controller. The feedback signal generation circuit includes a register that stores the next step number corresponding to the rotation amount of the motor between two temporally adjacent carrier period event; a remaining step number control circuit that obtains a first remaining step number by subtracting the number of steps that could be processed for generating the feedback signal between the first carrier period event and the second carrier period event immediately following it from the first next step number stored in the register at the time the first carrier period event occurs; a total step number control circuit that obtains a second total step number by adding the second next step number stored in the register and the first remaining step number at the time the second carrier period event occurs; and an output circuit that generates and outputs the feedback signal based on the second total step number.

Additionally, a representative embodiment is a motor control system comprising the semiconductor device, the controller, and the motor.

Furthermore, a representative embodiment is a motor control method comprising: a processor that generates and outputs a signal for controlling a motor based on instruction information input from a controller, and generates and outputs rotation amount information of the motor based on rotation angle information input from the motor side; a timer circuit that generates random modulation carrier period event; and a feedback signal generation circuit that generates a feedback signal corresponding to the motor's rotation angle based on the motor's rotation amount information input from the processor and the carrier period event generated by the timer circuit, and outputs it to the controller. The feedback signal generation circuit generates and outputs the feedback signal, including: a register that stores the next step number corresponding to the rotation amount of the motor between two temporally adjacent carrier period events; a remaining step number control circuit that obtains a first remaining step number by subtracting the number of steps that could be processed for generating the feedback signal between the first carrier period event and the second carrier period event immediately following it from the first next step number stored in the register at the time the first carrier period event occurs; a total step number control circuit that obtains the second total step number by adding the second next step number stored in the register and the first remaining step number at the time the second carrier period event occurs; and an output circuit that generates and outputs the feedback signal based on the second total step number.

According to one embodiment, in the method where a controller controls a motor via a semiconductor device, it is possible to reduce power consumption while ensuring control accuracy.

### BRIEF DESCRIPTION OF THE DRAWINGS

FIG. 1 is a diagram showing a configuration example of a motor control system.

FIG. 2 is a diagram for explaining switching losses.

FIG. 3 is a diagram showing a configuration example of an FB signal generation circuit according to the reference technology.

FIG. 4 is a diagram showing an example of the operation flow of an FB signal generation circuit according to reference technology.

FIG. 5 is a diagram showing an example of a timing chart of each signal or value related to the operation of an FB signal generation circuit according to reference technology.

FIG. 6 is a diagram showing an example of a carrier period event and carrier waveform when random modulation is applied to the carrier cycle.

FIG. 7 is a diagram showing an example of a timing chart of each signal, etc., in an FB signal generation circuit when random modulation is applied to the carrier cycle.

FIG. 8 is a diagram showing a configuration example of a motor control system and semiconductor device according to Embodiment 1.

FIG. 9 is a diagram showing a configuration example of an FB signal generation circuit according to Embodiment 1.

FIG. 10 is a diagram showing an example of the operation flow of an FB signal generation circuit according to Embodiment 1.

FIG. 11 is a diagram showing an example of a timing chart of each signal, etc., in an FB signal generation circuit according to Embodiment 1.

### DETAILED DESCRIPTION

### Background of the Study by the Inventors

### Configuration of Motor Control System

A motor control system is known in which a controller controls the rotation of a motor via a semiconductor device. Here, an example of the configuration and operation of such a motor control system is described below. In this specification, the rotation of the rotation shaft, rotation amount, rotation angle position, rotation speed, etc., of the motor are simply referred to as motor rotation, rotation amount, rotation angle position, rotation speed, etc. Also, in this specification, the rotation angle position of the motor is simply referred to as the motor's rotation angle.

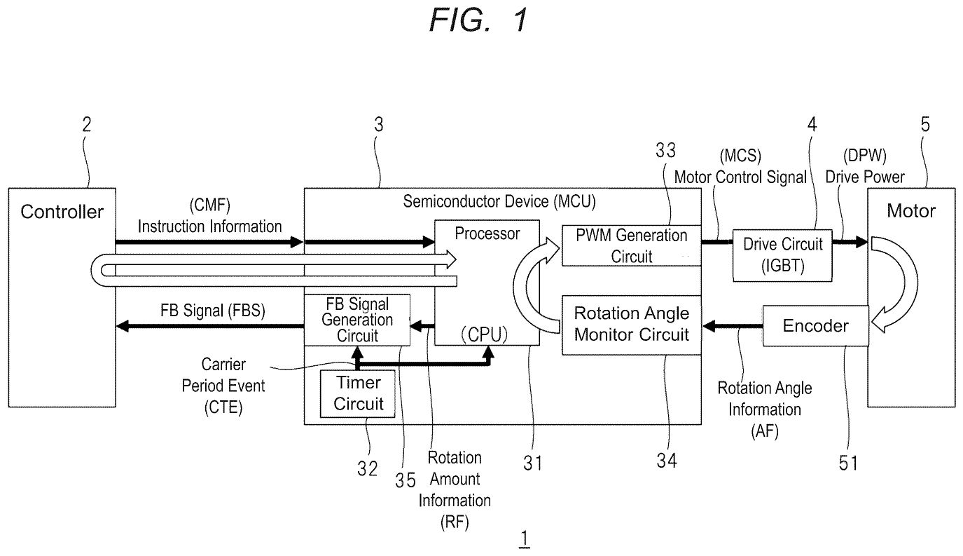

FIG. 1 is a diagram showing a configuration example of a motor control system. As shown in FIG. 1, motor control system 1 includes, for example, a controller 2, a semiconductor device 3, a drive circuit 4, and a motor 5.

Control 2 is provided outside the semiconductor device 3 and inputs instruction information CMF related to the rotation of the motor 5 into the semiconductor device 3. Control 2 is, for example, a higher-level controller positioned above the semiconductor device 3. The semiconductor device 3 generates a motor control signal MCS based on the input instruction information CMF and inputs it into the drive circuit 4. The drive circuit 4 supplies drive power (drive signal) DPW to the motor 5 based on the input motor control signal MCS. Driving circuit 4 is, for example, an IGBT (Insulated Gate Bipolar Transistor). The motor 5 is driven according to the supplied drive power DPW, and the rotation amount, rotation angle, rotation speed, etc., of the motor 5 are controlled. The motor 5 has an encoder 51. The encoder 51 outputs rotation angle information AF indicating the rotation angle of the motor 5. The motor 5 is, for example, a DC motor.

Semiconductor device 3 not only controls the rotation of the motor 5 but also monitors the rotation angle of the motor 5 with high real-time capability. The semiconductor device 3 generates a signal representing the rotation angle or rotation amount of the motor 5 based on the monitored rotation angle of the motor 5 as feedback (hereinafter referred to as FB) signal FBS to the controller 2 and sequentially outputs it to the controller 2.

To explain semiconductor device 3 in more detail, it is as follows. As shown in FIG. 1, the semiconductor device 3 is, for example, an MCU (Micro Controller Unit). The semiconductor device 3 also includes, for example, a processor 31, a timer circuit 32, a PWM (Pulse Width Modulation) generation circuit 33, a rotation angle monitor circuit 34, and an FB signal generation circuit 35.

Processor 31 generates a signal for controlling the motor 5 based on the instruction information CMF input from the controller 2 provided outside the semiconductor device 3 and outputs it to the PWM generation circuit 33. The processor 31 also generates rotation amount information RF of the motor 5 based on the rotation angle information AF input from the motor 5 side and outputs it to the FB signal generation circuit 35. Processor 31 is, for example, a CPU (Central Processing Unit).

The timer circuit 32 generates carrier period event CTE at a predetermined carrier cycle, that is, time interval. The timer circuit 32 outputs the generated carrier period event CTE to the processor 31 and the FB signal generation circuit 35. The carrier period event CTE refers to a pulse-like signal that occurs at a predetermined carrier cycle. Additionally, the carrier cycle is the period of the reference signal used to generate the PWM signal from the modulated wave.

The rotation angle monitor circuit 34 sequentially acquires the rotation angle information AF output from the encoder 51 and outputs it to the processor 31. The processor 31 controls the PWM generation circuit 33 based on the instruction information CMF input from the controller 2 and the rotation angle information AF input from the encoder 51.

The PWM generation circuit 33 generates a PWM signal as a motor control signal MCS under the control of processor 31. The PWM generation circuit 33 outputs the generated PWM signal to the drive circuit 4.

The processor 31 generates rotation amount information RF representing the amount of rotation of the motor 5 per carrier cycle based on the input carrier period event CTE and rotation angle information AF, and outputs it to the FB signal generation circuit 35.

The FB signal generation circuit 35 generates an FB signal FBS corresponding to the rotation angle of the motor 5 based on the rotation amount information RF of the motor 5 input from the processor 31 and the carrier period event CTE input from the timer circuit 32, and outputs it to the controller 2. The FB signal FBS is a signal equivalent to the output signal of a rotary encoder using, for example, an incremental method or a pseudo-absolute method.

According to the motor control system 1 configured as described above, the controller 2 can achieve feedback control of the rotation in the motor 5 via the semiconductor device 3, contributing to the expansion of design, cost reduction, and miniaturization in the motor control system.

Incidentally, in recent times, there has been a demand for reducing power consumption in motor control systems like the above mentioned system 1. One method to achieve this is by lowering the carrier frequency, that is, lengthening the carrier cycle, to reduce the switching loss in the drive circuit 4. Here, the switching loss of the drive circuit 4 is explained with reference to the figure.

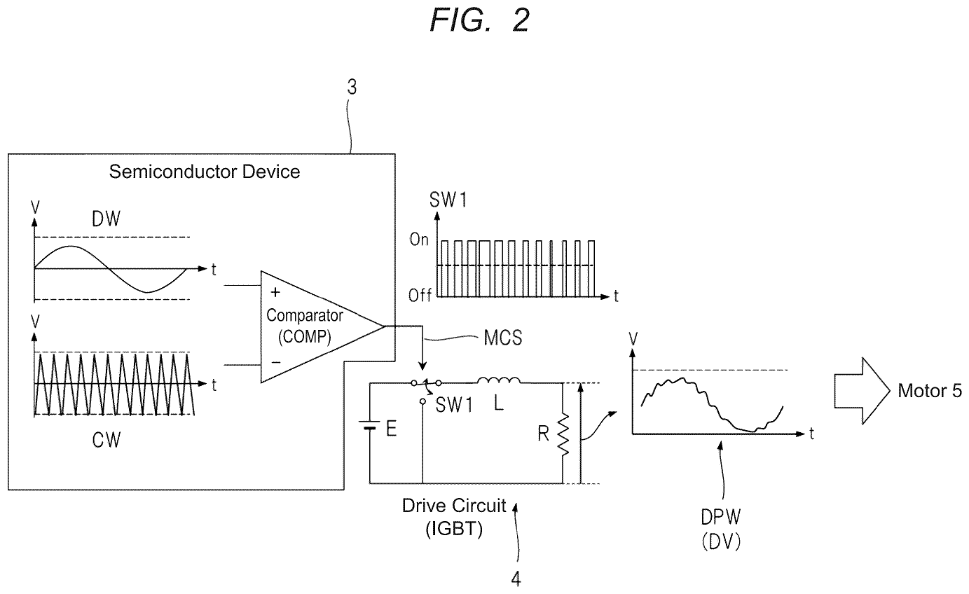

FIG. 2 is a diagram for explaining the switching loss. As shown in FIG. 2, semiconductor device 3 can be considered to have a comparator COMP as part of the PWM generation circuit 33. The signal of the modulated wave DW is input to the + input terminal of the comparator COMP, and the signal of the carrier wave CW is input to the − input terminal of the comparator COMP. The comparator COMP outputs an on-off signal, which is a PWM signal. The IGBT as the drive circuit 4 performs the switching operation of switch SW1 based on the PWM signal output from the semiconductor device 3. The drive power DPW (drive signal DV) output from the drive circuit 4 is supplied to the motor.

Here, if the frequency of the carrier wave CW is high, the switching frequency of the switch SW1 in the IGBT as the drive circuit 4 increases. Furthermore, the increase in current due to voltage changes near the switch SW1 also increases the loss. Therefore, to reduce the switching loss of the drive circuit 4, it is considered to lower the carrier frequency as mentioned above. However, if the carrier frequency is lowered sufficiently to achieve a significant reduction in the switching loss of the drive circuit 4, the carrier frequency tends to enter the audible range. When the carrier frequency enters the human audible range, noise countermeasures are also necessary.

Therefore, in the semiconductor device 3 mentioned above, it is considered to adopt not only the method based on the reference technology where the carrier cycle is constant but also a method where the carrier cycle changes randomly (random modulation method). In this case, it is necessary to output the FB signal to the controller 2 in response to the variable carrier period event.

### Configuration of FB Signal Generation Circuit Based on Reference Technology

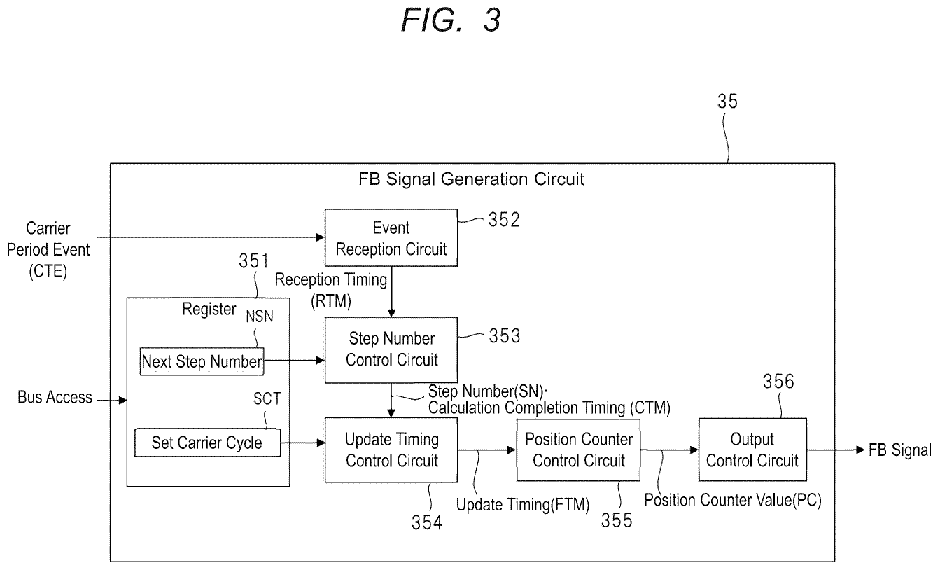

Here, an example of the configuration and operation of the FB signal generation circuit based on reference technology is explained. FIG. 3 is a diagram showing an example of the configuration of the FB signal generation circuit based on reference technology. As shown in FIG. 3, the FB signal generation circuit 35 based on reference technology includes, for example, a register 351, an event reception circuit 352, a step number control circuit 353, an update timing control circuit 354, a position counter control circuit 355, and an output control circuit 356.

The register 351 stores the next step NSN and the set carrier cycle SCT. The next step NSN represents the amount of rotation of the motor 5 between the two most recent carrier period event CTE in terms of step numbers. The next step number NSN is determined by the processor 31 based on the input carrier period event CTE and the rotation angle information AF of the motor 5 obtained from the rotation angle monitor circuit 34. The set carrier cycle SCT is the period of the carrier period event CTE output by the timer circuit 32.

The event reception circuit 352 receives the carrier period event CTE output from the timer circuit 32 and sends the reception timing RTM to the step number control circuit 353.

The step number control circuit 353 synchronizes with the reception timing RTM of the carrier period event CTE to acquire the next step number NSN stored in register 351 as the step number SN. The step number control circuit 353 sends the acquired step number SN and the calculation completion timing CTM to the update timing control circuit 354.

The update timing control circuit 354 calculates the time interval Δt of the output update timing FTM based on the step number SN and the set carrier cycle SCT stored in register 351. The update timing FTM is a timing signal that serves as a trigger for updating the position counter value PC, which is described later. The update timing control circuit 354 calculates the time interval Δt of the update timing FTM by dividing the set carrier cycle SCT by the step number SN, for example. The update timing control circuit 354 outputs the update timing FTM to the position counter control circuit 355 in synchronization with the calculation completion timing CTM and at the calculated time interval Δt.

The position counter control circuit 355 is equipped with a position counter representing the rotation angle position of motor 5. The position counter control circuit 355 updates the position counter value PC, which is the value of the position counter, when the update timing FTM is input. The position counter control circuit 355 increments and updates the position counter when the motor 5 is rotating in a predetermined direction and decrements and updates the position counter when the motor 5 is rotating in the opposite direction to the predetermined direction. The position counter value PC returns to a reference value, for example, 0, when the motor 5 completes one rotation. For example, if a value of 1 is assigned to a rotation angle of 1 degree, the position counter takes value from 0 to 359.

The output control circuit 356 generates and outputs the FB signal FBS based on the position counter value PC. The output control circuit 356 pseudo-generates a signal waveform obtained by a rotary encoder using, for example, an incremental method or a pseudo-absolute method as the FB signal FBS. That is, when pseudo-generating the signal waveform of a rotary encoder using the incremental method, on-off waveforms for each of phase A and phase B are generated. When pseudo-generating the signal waveform of a rotary encoder using the pseudo-absolute method, on-off waveforms for each of phase A, phase B, and phase Z are generated.

As understood from the above, the FB signal generation circuit 35 reproduces the movement of the motor 5 as the FB signal FBS based on the carrier period event CTE and the step number SN (rotation amount information of the motor 5). To reproduce the movement of the motor 5 from the carrier period event CTE and the step number SN, it is necessary to determine when to update the FB signal. In the reference technology, since the carrier period event CTE is constant, the position counter value PC is counted up (or down) at equal intervals based on the set carrier cycle SCT (register value) by the number of times of the next step NSN (rotation angle information), and the FB signal FBS corresponding to the position counter value PC is output.

### Operation Flow of FB Signal Generation Circuit Based on Reference Technology

Next, an example of the operation flow of the FB signal generation circuit 35 based on reference technology and an example of the timing chart of each signal related to the operation of the FB signal generation circuit 35 is explained.

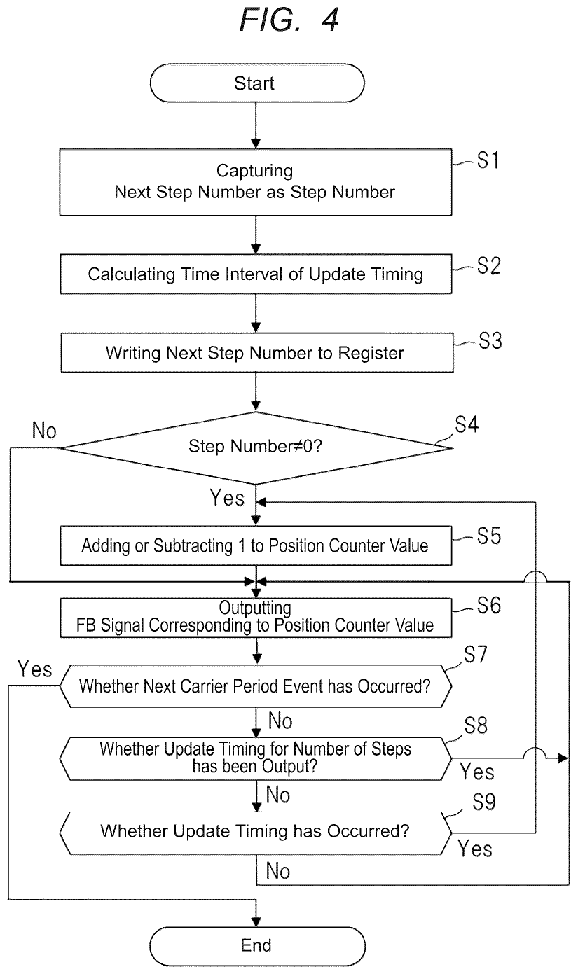

FIG. 4 is a diagram showing an example of the operation flow of the FB signal generation circuit based on reference technology. The operation flow shown in FIG. 4 indicates the flow of operations per carrier cycle CT, and in practice, this operation flow is repeated for each carrier cycle CT.

As shown in FIG. 4, in step S1, the process of capturing the next step number as the step number is executed. Specifically, the step number control circuit 353 captures the next step number NSN stored in register 351 as the step number SN into the step number control circuit 353.

In step S2, the process of calculating the time interval of the update timing is executed. Specifically, the update timing control circuit 354 acquires the step number SN from the step number control circuit 353 and captures it into the update timing control circuit 354. The update timing control circuit 354 calculates the time interval At of the update timing FTM based on the set carrier period SCT stored in the register 351 and the number of steps SN taken from the step number control circuit 353. Additionally, the update timing control circuit 354 outputs the update timing FTM to the position counter control circuit 355 at intervals of the time interval Δt, synchronized with the calculation completion timing CTM input from the step number control circuit 353.

In step S3, the process of writing the next step number to the register is executed. Specifically, processor 31 writes the next step NSN, corresponding to the rotation amount of the motor 5 between the two most recent carrier period events CTE, into register 351.

In step S4, the process of determining whether the step number is a value other than 0 (step number≠0) is executed. Specifically, the update timing control circuit 354 determines whether the step number SN stored internally in the update timing control circuit 354 is not equal to 0. Here, if it is determined that the step number SN is not equal to 0 (step S4: Yes), the processing step moves to step S5. On the other hand, if it is determined that the step number SN is equal to 0 (step S4: No), the processing step moves to step S6.

In step S5, the process of adding or subtracting 1 to the position counter value is executed. Specifically, when the update timing FTM is input, the position counter control circuit 355 adds 1 (count up) or subtracts 1 (count down) to the position counter value PC representing the rotation angle of the motor 5. For example, if the step number SN is a positive value (SN>0), the position counter control circuit 355 adds 1 to the position counter value PC. Additionally, if the step number SN is a negative value (SN<0), the position counter control circuit 355 subtracts 1 from the position counter value PC.

In step S6, the process of outputting an FB signal corresponding to the position counter value is executed. Specifically, the output control circuit 356 generates and outputs an FB signal FBS corresponding to the rotation angle of the motor 5 represented by the current position counter value PC.

In step S7, the process of determining whether the next carrier period event has occurred (or is occurring) is executed. Specifically, the step number control circuit 353 determines whether the next carrier period event CTE has occurred. Here, if it is determined that the next carrier period event CTE has occurred (step S7: Yes), the FB signal generation process per carrier period CT is completed. On the other hand, if it is determined that the next carrier period event CTE has not occurred (step S7: No), the processing step moves to step S8.

In step S8, the process of determining whether the update timing for the number of steps has been output is executed. Specifically, the update timing control circuit 354 determines whether the update timing FTM has been output for the number of steps SN. Here, if it is determined that the output has been made for the number of steps SN (step S8: Yes), the processing step returns to step S6. On the other hand, if it is determined that the output has not been made for the number of steps SN (step S8: No), the processing step moves to step S9.

In step S9, the process of determining whether the update timing has occurred (or is occurring) is executed. Specifically, the update timing control circuit 354 determines whether the update timing FTM has occurred. Here, if it is determined that the update timing FTM has occurred (step S9: Yes), the processing step returns to step S5, and the position counter value is updated. On the other hand, if it is determined that the update timing FTM has not occurred (step S9: No), the processing step returns to step S6.

### Signals and the Like in the FB Signal Generation Circuit According to Reference Technology

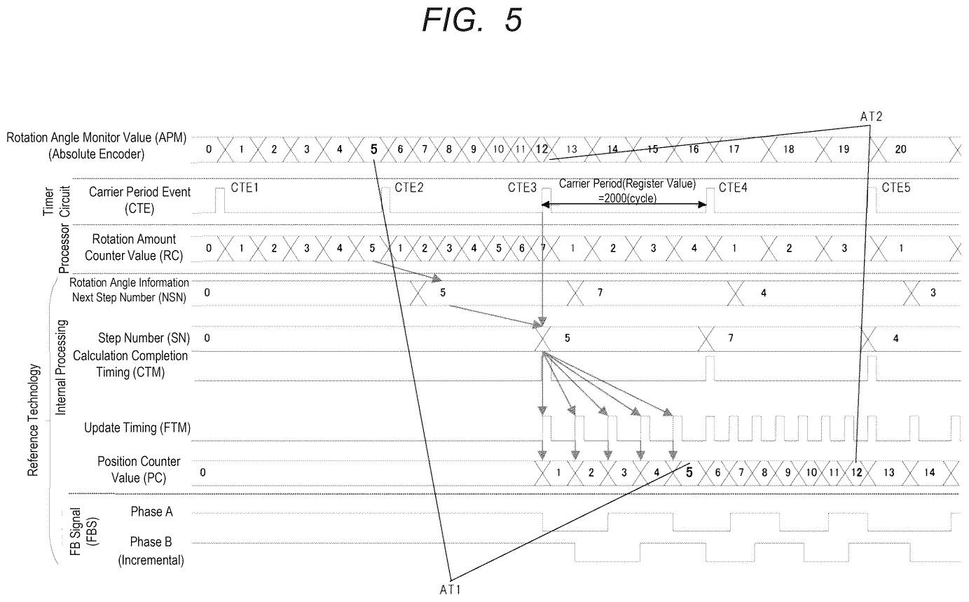

FIG. 5 is a diagram showing an example of a timing chart of each signal or value related to the operation of the FB signal generation circuit according to the reference technology. The example shown in FIG. 5 shows each signal, etc., in a state where the rotation shaft of the motor 5 is rotating in a predetermined rotation direction while changing the rotation speed. In the example shown in FIG. 5, the time changes of [rotation angle monitor value (APM)] in the rotation angle monitor circuit 34, [carrier period event (CTE)] output from the timer circuit 32, [rotation amount counter value (RC)] in the processor 31, various signals and values related to the internal processing of the FB signal generation circuit 35, and [FB signal (FBS)] are shown.

The various signals and values related to the internal processing of the FB signal generation n circuit 35 are specifically [next step number (NSN)], [step number (SN)], [calculation completion timing CTM], [update timing (FTM)], and [position counter value (PC)]. It is assumed that the [rotation angle monitor value (APM)] is based on an absolute encoder. It is assumed that the [FB signal (FBS)] is based on an incremental encoder.

The [rotation angle monitor value] takes values from 0 to 359, for example, and corresponds to the rotation angle of the motor 5 represented in increments of one degree) (1°). In this example, the [rotation angle monitor value] gradually changes from 0 to larger values over time.

The [carrier period event] is output from the timer circuit 32 at the time interval of the set carrier period SCT stored in register 351. In this example, the set carrier period SCT is 0.5 ms. That is, the carrier frequency is 2 kHz (2000 cycles per second). In the example of FIG. 5, five carrier period event CTE from CTE1 to CTE5 are described.

The [rotation amount counter value] corresponds to the rotation angle amount of the motor 5. One unit of the [rotation amount counter value] corresponds to one degree) (1°) of the rotation angle amount of the motor 5. However, the [rotation amount counter value] sequentially represents the rotation angle amount of the motor 5 between temporally adjacent carrier period events CTE. Therefore, the [rotation amount counter value] is reset each time a carrier period event CTE is output and is recounted from 1. The [rotation amount counter value] is stored by processor 31.

The [next step number] represents the rotation angle amount of the motor 5 between the two most recent carrier period events CTE. The [next step number] is the value of the [rotation amount counter value] at the time the carrier period event CTE is output, which is captured and stored after the output of the carrier period event CTE.

The [step number] is the value of the [next step number] at the time the carrier period event CTE is output, which is captured and stored immediately after the output of the carrier period event CTE.

The [calculation completion timing] is output when the calculation to determine the time interval Δt for outputting the [update timing] is completed after the [step number] is updated. Since this calculation is performed at high speed, the [calculation completion timing] is almost synchronized with the [carrier period event].

The [update timing] is output triggered by the [calculation completion timing] according to the calculated time interval Δt.

The [position counter value], like the [rotation angle monitor value], corresponds to the rotation angle of the motor 5 represented in increments of one degree (1°). The [position counter value] is sequentially updated in response to the [update timing]. Therefore, the [position counter value] reflects the [rotation angle monitor value] at the point two periods before the carrier period event CTE.

As shown in FIG. 5, if the [rotation angle monitor value] is 5 when the carrier period event CTE2 is output, the [position counter value] becomes 5 two periods later, i.e., when the carrier period event CTE4 is output (see the part indicated by symbol AT1 in FIG. 5). Similarly, if the [rotation angle monitor value] is 12 when the carrier period event CTE3 is output, the [position counter value] becomes 12 two periods later, i.e., when the carrier period event CTE5 is output (see the part indicated by symbol AT2 in FIG. 5).

The [FB signal] is a signal corresponding to the rotation angle position of the motor 5 based on the [position counter value]. The [FB signal] outputs 90 pulses each in phase A and phase B during one rotation of the rotation shaft of the motor 5, with a phase difference of 90 degrees (90°) between phase A and phase B.

### Newly Discovered Issues by the Inventor

In reference to technology, the carrier period CT was constant. However, as mentioned above, a method of randomly modulating the carrier period CT can be considered to reduce power consumption. The reason for adopting this method is explained again as follows. To reduce power consumption, it is necessary to reduce the switching loss in the drive circuit 4. To reduce switching loss, it is effective to lower the carrier frequency CF. To sufficiently reduce switching loss, it is necessary to lower the carrier frequency CF to the audible range. When the carrier frequency CF enters the audible range, the operating frequency in the drive circuit 4 enters the audible range, making noise at specific frequencies more pronounced. Therefore, by randomly modulating the carrier frequency CF, the operational energy is dispersed, and noise at specific frequencies is reduced.

The inventor has newly discovered that when random modulation is applied to the carrier period CT in the motor control system 1 as described above, there are challenges that were not present in the method according to the reference technology. The following describes the challenges newly discovered by the inventor.

In reference technology, in the motor control system 1 that transmits the rotation amount of the motor 5 to the controller 2, PWM can be performed at a constant carrier frequency CF outside the audible range. Therefore, in the design of the semiconductor device 3, particularly the FB signal generation circuit 35, a design based on equally spaced carrier period event CTE was sufficient. However, when random modulation is applied to the carrier period CT, naturally, the time intervals of the carrier period event CTE are not equally spaced.

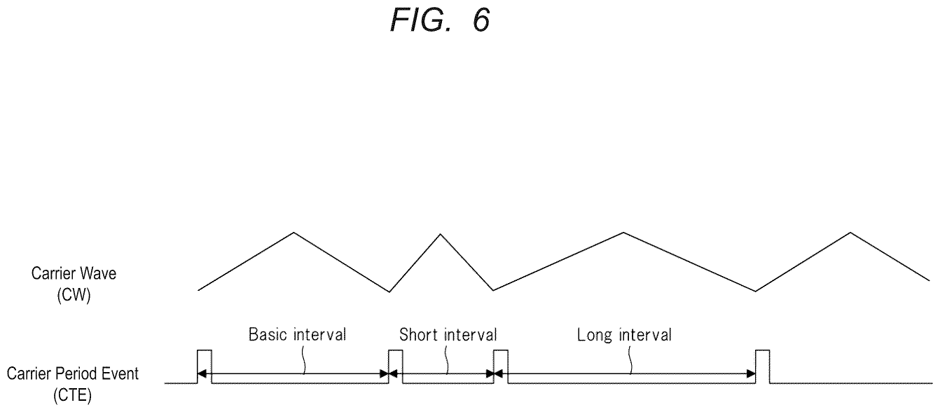

FIG. 6 is a diagram showing an example of carrier period event and carrier waveforms when random modulation is applied to the carrier period. As shown in FIG. 6, when random modulation is applied to the carrier period CT, the time intervals of the carrier period even CTE fluctuate, becoming shorter or longer, and the waveform of the carrier wave CW also compresses or expands in the time axis direction.

If the number of steps SN captured by the step number control circuit 353 is relatively large and the time interval of the carrier period event CTE becomes considerably short, the update timing control circuit 354 may not be able to output the update timing FTM for the number of steps SN. This can occur, for example, when calculating the time interval of the update timing FTM using the fixed set carrier period SCT stored in the register 351, resulting in the necessary number of update timings FTM not fitting within the time interval of the carrier period event CTE. It can also occur if the operating speed of continuously generating the update timing FTM by the update timing control circuit 354 does not keep up with the required operating speed.

If the update timing control circuit 354 cannot output the update timing FTM for the number of steps SN, the number of steps that could not be output is not compensated and disappears. This is easy to understand when considering the processing of step S1 in the operation flow of FIG. 4. In step S1, regardless of whether the update timing FTM for the number of steps SN has been output, the next step number NSN is captured as the step number SN at the timing when the carrier period event CTE occurs (FIG. 4, step S7: Yes→End→Start).

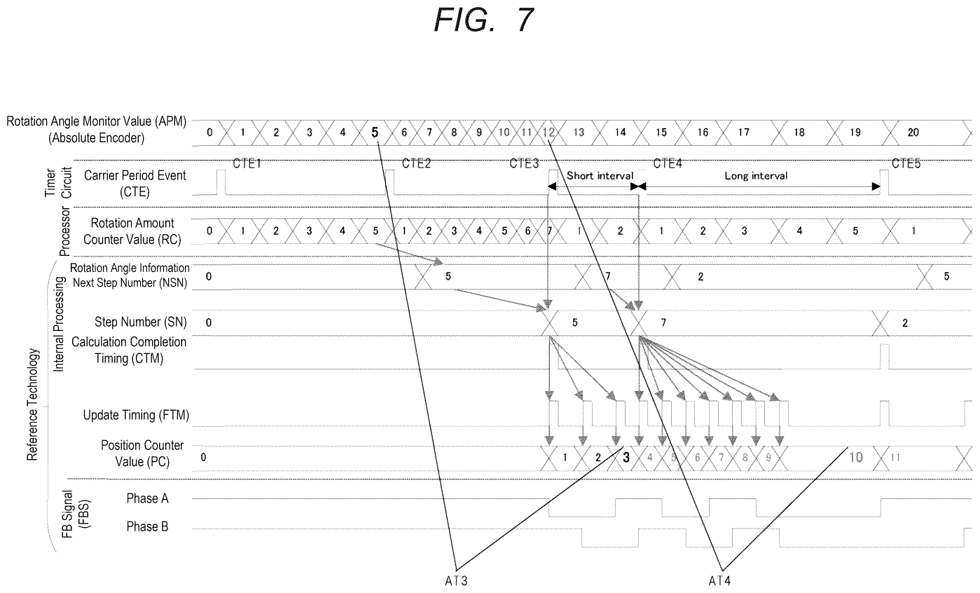

FIG. 7 is a diagram showing an example of a timing chart of each signal in the FB signal generation circuit when random modulation is applied to the carrier period. As shown in FIG. 7, when the carrier period event CTE2 is output and the [rotation angle monitor value] is 5, the [step number] immediately after the next carrier period event CTE3 is output becomes 5. The time interval Δt of the [update timing] is the time obtained by dividing the set carrier period SCT by the value of the [step number], which is 5. That is, the [update timing] is planned to output 5 [update timings] between the carrier period event CTE3 and the next carrier period event CTE4, assuming that the carrier period CT is constant.

However, in reality, the carrier period CT is randomly modulated. Therefore, for example, it is conceivable that the interval between the carrier period event CTE3 and the next carrier period event CTE4 becomes shorter than the set carrier period SCT.

For example, as shown in FIG. 7, when the carrier period event CTE2 is output and the [rotation angle monitor value] is 5, 5 [update timings] have to be output between the carrier period event CTE3 and the carrier period event CTE4. However, for example, it is conceivable that between the carrier period event CTE3 and the carrier period event CTE4, only 3 [update timings] are output, and 2 remain unoutput.

In this case, two periods after the carrier period event CTE2, that is, when the carrier period event CTE4 is output, the [position counter value] becomes 3 (see the part indicated by the symbol AT3 in FIG. 7). In other words, the [step number] is 5, and while processing 5 steps is required, 2 steps remain unprocessed. At the time when the carrier period event CTE4 is output, the [next step number] at that time is captured as the value of the [step number]. Therefore, the 2 unprocessed steps out of the 5 step numbers disappear.

Also, as shown in FIG. 7, when the carrier period event CTE3 is output and the [rotation angle monitor value] is 12, two periods after that carrier period event CTE3, that is, when the carrier period event CTE5 is output, the [position counter value] becomes 10, with the 2 lost steps not recovered (see the part indicated by the symbol AT4 in FIG. 7).

Thus, when some of the step numbers SN disappear, the rotational operation of the motor 5 is not reproduced as information in the FB signal generation circuit 35. That is, an FB signal FBS corresponding to a rotation angle deviated from the actual rotation angle of the motor 5 is output, and incorrect rotation angle information is transmitted to the controller 2. Therefore, the controller 2 cannot accurately control the motor 5.

### First Embodiment

The inventor, as a result of diligent study to solve the above problems, devised the present invention. Hereinafter, the embodiment of the present invention is described. The semiconductor device according to the first embodiment of the present invention manages the unprocessed step numbers among the step numbers SN as the remaining step number RSN, adds the remaining step number RSN to the next step number NSN to calculate the total step number TSN, and generates and outputs the FB signal based on the total step number TSN.

### Configuration of Motor Control System and Semiconductor Device According to First Embodiment

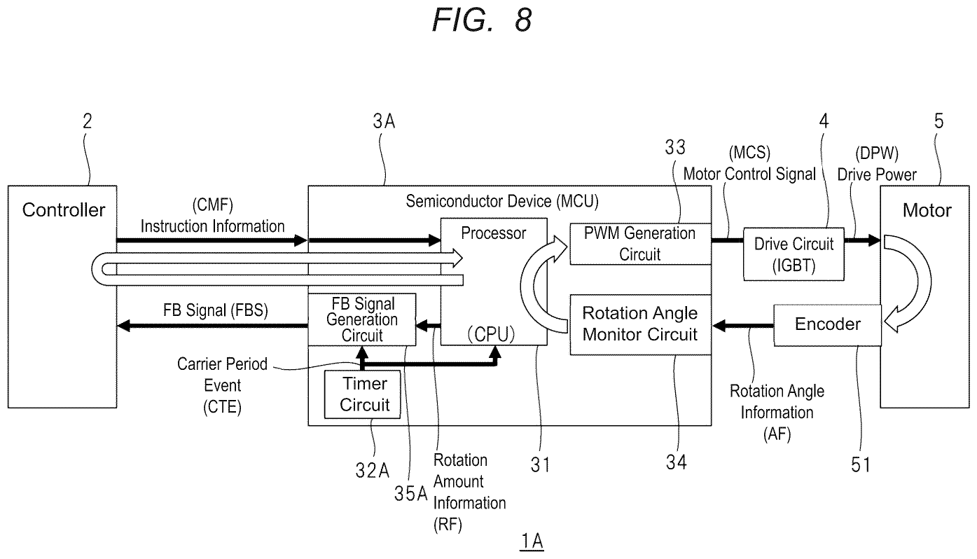

FIG. 8 is a diagram showing a configuration example of the motor control system and semiconductor device according to the first embodiment. As shown in FIG. 8, motor control system 1A according to the first embodiment includes a semiconductor device 3A instead of the semiconductor device 3 when compared to motor control system 1 according to reference technology. The semiconductor device 3A according to the first embodiment includes a timer circuit 32A instead of the timer circuit 32 and an FB signal generation circuit 35A instead of the FB signal generation circuit 35 when compared to the semiconductor device 3 according to the reference technology.

The timer circuit 32 according to the reference technology generated carrier period event CTE at a constant carrier period. On the other hand, the timer circuit 32A according to the first embodiment generates carrier period event CTE with random modulation applied. That is, the timer circuit 32A generates carrier period event CTE such that the time interval (carrier period) between the carrier period event CTE changes randomly. At least a part of the longer carrier period CT in the carrier period event CTE generated by the timer circuit 32A is long enough to enter the human audible range. This reduces the switching loss of the drive circuit 4 and suppresses noise.

### Configuration of FB Signal Generation Circuit According to First Embodiment

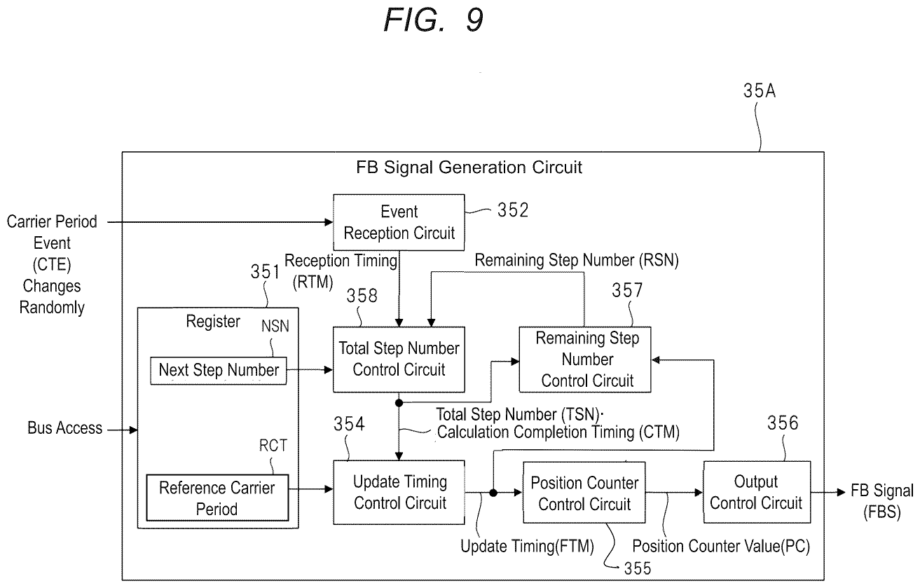

FIG. 9 is a diagram showing a configuration example of the FB signal generation circuit according to the first embodiment. As shown in FIG. 9, the FB signal generation circuit 35A according to the first embodiment differs from the FB signal generation circuit 35 according to reference technology in the following points.

In the FB signal generation circuit 35A, register 351 stores the reference carrier period RCT instead of the set carrier period SCT. The reference carrier period RCT refers to a representative carrier period in the carrier period event CTE with random modulation. The reference carrier period RCT is, for example, a period corresponding to the average or median of the fluctuating carrier period CT. Also, for example, it is the reciprocal of the central frequency in the fluctuation range of the carrier frequency CF. If the carrier frequency CF fluctuates between 6 kHz and 10 kHz, the reference carrier frequency RCF is, for example, 8 kHz, and the reference carrier period RCT is the reciprocal of the reference carrier frequency RCF, which is 8 kHz.

Note that register 351 also stores the next step number NSN corresponding to the rotation amount of the motor 5 between two temporally adjacent carrier period events CTE, as in the case of the reference technology, but there is no difference in this function.

Also, in the FB signal generation circuit 35A, a remaining step number control circuit 357 is newly added. Furthermore, instead of the step number control circuit 353, a total step number control circuit 358 is provided.

The remaining step number control circuit 357 stores the number of steps that remain unprocessed among the steps to be processed to generate the FB signal FBS between the two most recent carrier period events CTE as the remaining step number RSN internally.

When the carrier period event CTE is input, the total step number control circuit 358 adds the next step number NSN stored in register 351 and the remaining step number RSN stored in the remaining step number control circuit 357 to obtain the step number, which is captured internally as the total step number TSN. The total step number control circuit 358 outputs the total step number TSN to the update timing control circuit 354.

The update timing control circuit 354 calculates the time interval Δt of the update timing FTM based on the reference carrier period RCT stored in the register 351 and the total step number TSN input from the total step number control circuit 358. The time interval Δt of the update timing FTM is obtained, for example, by dividing the reference carrier period RCT by the total step number TSN. The update timing control circuit 354 outputs the update timing FTM for the total step number TSN to the position counter control circuit 355 at the calculated time interval Δt.

The position counter control circuit 355 updates the internal position counter value PC when the update timing FTM is input.

The output control circuit 356 generates an FB signal FBS based on the position counter value PC inside the position counter control circuit 355 and outputs it to the controller 2.

Here, how each of the remaining step number control circuit 357, total step number control circuit 358, update timing control circuit 354, position counter control circuit 355, and output control circuit 356 functions in the flow of a series of processes based on the occurrence of the carrier period event CTE is described.

The remaining step number control circuit 357 obtains the first remaining step number RSN_1 by subtracting the number of steps that could be processed for generating the FB signal FBS between the first carrier period event CTE_1 and the immediately following second carrier period event CTE_2 from the first next step number NSN_1 stored in the register 351 at the time the first carrier period event CTE_1 occurs.

For example, the remaining step number control circuit 357 captures the value of the first total step number TSN_1 immediately before the second total step number TSN_2 as an internal counter value in response to the occurrence of the first carrier period event CTE_1. Then, the remaining step number control circuit 357 obtains the first remaining step number RSN_1 by subtracting and updating the internal counter value by 1 each time the update timing FTM is input.

However, if the first update timing FTM_1 among the multiple update timings FTM corresponding to the first total step number TSN_1 is output in response to the occurrence of the first carrier period event CTE_1, a value obtained by subtracting 1 in advance from the value of the first total step number TSN_1 may be used as the initial value of the remaining step number RSN. That is, the remaining step number control circuit 357 stores the value of the total step number TSN-1 as the initial value of the remaining step number RSN when the carrier period event CTE is input. Then, the remaining step number control circuit 357 subtracts and updates the stored remaining step number RSN by 1 each time the update timing FTM is output, that is, each time the position counter value PC is updated. The remaining step number control circuit 357, through the above operation, always stores the unprocessed step number as the remaining step number RSN.

The remaining step number control circuit 357 obtains the first remaining step number RSN_1 when the number of steps that can be processed for generating the FB signal FBS within the first time ΔT1 is smaller than the first next step number NSN_1, due to the first time ΔT1 between the first carrier period event CTE_1 and the second carrier period event CTE_2 being shorter than the reference carrier period RCT.

The total step number control circuit 358 obtains the second total step number TSN_2 by adding the second next step number NSN_2 stored in register 351 and the first remaining step number RSN_1 at the time the second carrier period event CTE_2 occurs.

The update timing control circuit 354 receives the second total step number TSN_2 from the total step number control circuit 358. The update timing control circuit 354 determines the time interval Δt of the update timing FTM based on the reference carrier period RCT and the second total step number TSN_2, and outputs the update timing FTM to the remaining step number control circuit 357 at the determined time interval Δt. The update timing control circuit 354 determines the time interval Δt of the update timing FTM by dividing the reference carrier period RCT by the second total step number TSN_2, for example.

The position counter control circuit 355 updates the position counter value PC, which reproduces the rotational angle position of the motor 5, in synchronization with the update timing FTM.

The output control circuit 356 generates the FB signal FBS based on the updated position counter value PC.

It should be noted that the update timing control circuit 354, position counter control circuit 355, and output control circuit 356 are examples of the “output circuit” in this application. Additionally, the processor 31, timer circuit 32, and FB signal generation circuit 35A may be formed on a semiconductor chip.

According to such an FB signal generation circuit 35A, in the FB signal generation processing corresponding to one carrier period event CTE, the unprocessed step number among the step number SN representing the rotation amount of the motor 5 is managed as the remaining step number RSN. Then, in the FB signal generation processing corresponding to the next carrier period event CTE, the remaining step number RSN is added to the step number SN representing the rotation amount of the motor 5 and processed. Such processing can avoid the loss of unprocessed step numbers.

### Operation Flow of FB Signal Generation Circuit According to First Embodiment

An example of the operation flow of the FB signal generation circuit 35A according to the first embodiment and an example of the timing chart of each signal related to the operation of the FB signal generation circuit 35A is described.

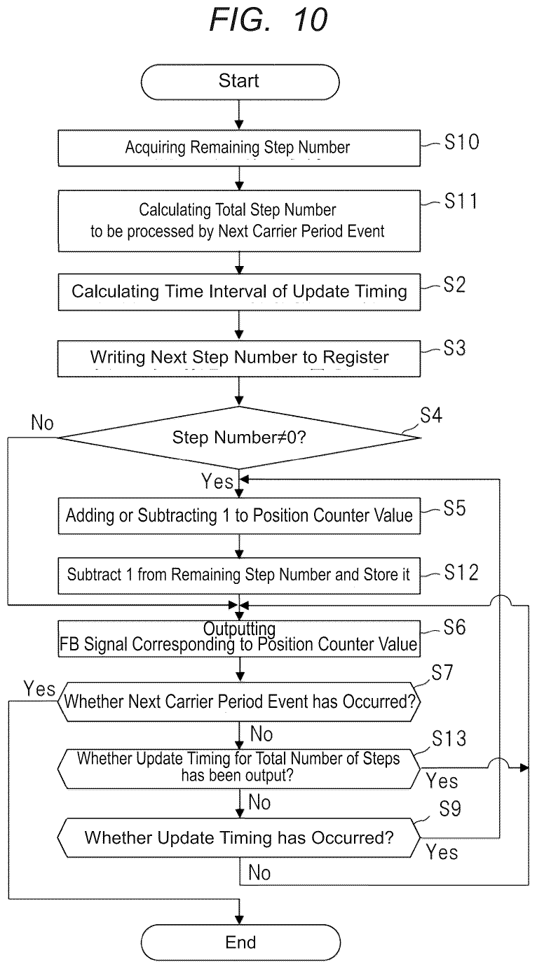

FIG. 10 is a diagram showing an example of the operation flow of the FB signal generation circuit according to the first embodiment. As shown in FIG. 10, in the operation flow of the FB signal generation circuit according to the first embodiment, compared to the operation flow of the FB signal generation circuit according to the reference technology in FIG. 4, steps S10 to S11 are added instead of step S1, step S12 is added between steps S5 and S6, and step S13 is further added instead of step S8. The processing of steps S2 to S5, steps S6 to S7, S13, and S9 according to the first embodiment is almost the same as the processing of steps S2 to S5, steps S6 to S9 according to the reference technology. However, the step number SN needs to be read as the total step number TSN.

As shown in FIG. 10, in step S10, the process of acquiring the remaining step number is executed. Specifically, the total step number control circuit 358 acquires the remaining step number RSN stored in the remaining step number control circuit 357 from the remaining step number control circuit 357. Then, the processing step proceeds to step S11.

In step S11, the process of calculating the total step number to be processed by the next carrier period event is executed. Specifically, the total step number control circuit 358 calculates the total step number TSN by adding the remaining step number RSN acquired from the remaining step number control circuit 357 to the next step number NSN stored in the register 351. The remaining step number control circuit 357 stores the calculated total step number TSN as the remaining step number RSN. Then, the processing step proceeds to step S2.

In step S2, the process of calculating the time interval of the update timing is executed. Specifically, the update timing control circuit 354 acquires the total step number TSN from the total step number control circuit 358 and stores it internally in the update timing control circuit 354. The update timing control circuit 354 calculates the time interval Δt of the update timing FTM based on the reference carrier period RCT stored in the register 351 and the total step number TSN acquired from the total step number control circuit 358. For example, the time interval Δt is calculated by dividing the reference carrier period RCT by the total step number TSN. In addition, the update timing control circuit 354 transmits the update timing FTM to the position counter control circuit 355 at the interval of the time interval Δt in synchronization with the calculation completion timing CTM received from the total step number control circuit 358.

In step S3, the process of writing the next step number to the register is executed. Specifically, processor 31 writes the next step number NSN corresponding to the rotation amount of the motor 5 between the most recent two carrier period event CTE to the register 351.

In step S4, the process of determining whether the total step number is a value different from 0 (total step number≠0) is executed. Specifically, the update timing control circuit 354 determines whether the total step number TSN≠0 stored in the processing unit of the update timing control circuit 354. Here, if it is determined that the total step number TSN≠0 (step S4: Yes), the processing step proceeds to step S5. On the other hand, if it is determined that the total step number TSN≠0 is not true (step S4: No), the processing step proceeds to step S6.

In step S5, the process of adding 1 or subtracting 1 to the position counter value is executed. Specifically, the position counter control circuit 355 adds 1 (count up) or subtracts 1 (count down) to the position counter value PC representing the rotational angle position of the motor 5 each time the update timing FTM is received. For example, the position counter control circuit 355 adds 1 to the position counter value PC when the total step number TSN is a positive value (TSN>0). Additionally, the position counter control circuit 355 subtracts 1 from the position counter value PC when the total step number TSN is a negative value (TSN<0). Subsequently, the processing step proceeds to step S12.

In step S12, a process is executed to subtract 1 from the remaining step number and store it. Specifically, the remaining step number control circuit 357 subtracts 1 from the remaining step number RSN stored in the remaining step number control circuit 357 and stores the resulting step number as the new remaining step number RSN. Subsequently, the processing step proceeds to step S6.

In step S6, a process is executed to generate and output an FB signal corresponding to the position counter value. Specifically, the output control circuit 356 generates and outputs an FB signal FBS corresponding to the rotational angle position of the motor 5 represented by the current position counter value PC.

In step S7, a process is executed to determine whether the next carrier period event has occurred (or is occurring). Specifically, the step number control circuit 353 determines whether the next carrier period event CTE has occurred. Here, if it is determined that the next carrier period event CET has occurred (step S7: Yes), the FB signal generation process per carrier cycle CT is completed. On the other hand, if it is determined that the next carrier period event CTE has not occurred (step S7: No), the processing step proceeds to step S13.

In step S13, a process is executed to determine whether the update timing for the total number of steps has been output. Specifically, the update timing control circuit 354 determines whether the update timing FTM has been output for the total number of steps TSN. Here, if it is determined that the output has been made for the total number of steps TSN (step S13: Yes), the processing step proceeds to step S6. On the other hand, if it is determined that the output has not been made for the total number of steps TSN (step S13: No), the processing step proceeds to step S9.

In step S9, a process is executed to determine whether the update timing has occurred. Specifically, the update timing control circuit 354 determines whether the update timing FTM has occurred. Here, if it is determined that the update timing FTM has occurred (step S9: Yes), the processing step returns to step S5, and the position counter value is updated. On the other hand, if it is determined that the update timing FTM has not occurred (step S9: No), the processing step returns to step S6.

### Timing Chart of Each Signal in Embodiment 1

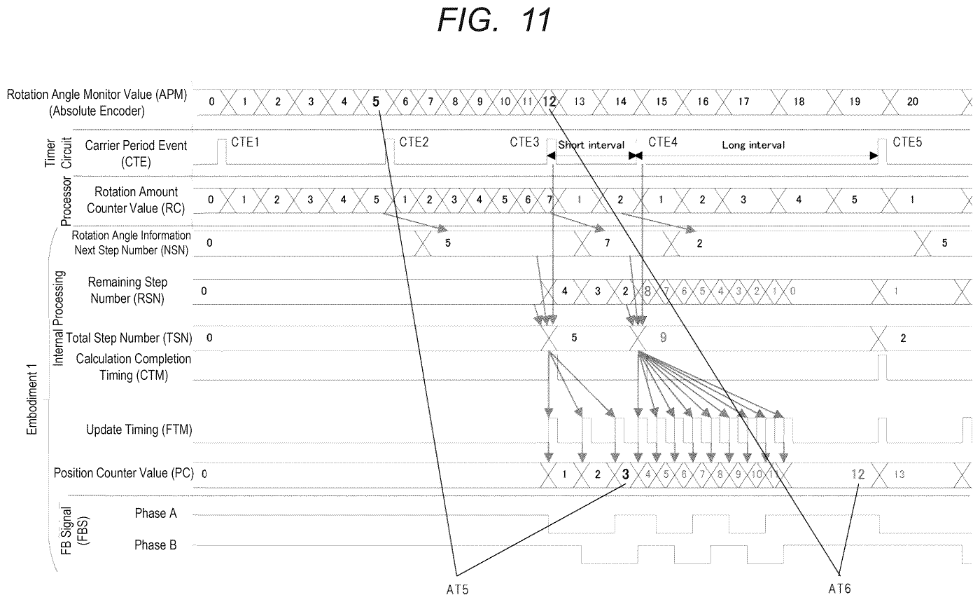

FIG. 11 is a diagram showing an example of a timing chart of each signal in the FB signal generation circuit according to Embodiment 1. As shown in FIG. 11, for example, it is assumed that the interval between the carrier period event CTE3 and the carrier period event CTE4 becomes shorter than the reference carrier cycle RCT. It is also assumed that between the carrier period event CTE3 and the carrier period event CTE4, three [update timings] are output, and two are not output. In other words, the [step number] is 5, and while processing 5 steps is required, 2 steps remain unprocessed.

However, at the point when the carrier period event CTE4 is output, the [remaining step number] is 2, representing the 2 unprocessed steps. Also, at this point, the [total step number] becomes 9 by adding 2, the value of the [remaining step number], to 7, the value of the [next step number]. If the interval between the carrier period event CTE4 and the carrier period event CTE5 is sufficiently long, the pulse signal of the [update timing] is output for 9 times based on the value of the [total step number], which is 9. Even if the interval between the carrier period event CTE4 and the carrier period event CTE5 is not sufficiently long and unprocessed steps occur again, the unprocessed step number is carried over as the remaining step number RSN. Then, the unprocessed steps can be processed at a time when the interval between subsequent carrier period events CTE becomes sufficiently long.

In the example shown in FIG. 11, the [rotation angle monitor value] at the time corresponding to the carrier period event CTE2 is 5, and the [position counter value] at the time corresponding to the carrier period event CTE4, two cycles later, is 3 (see the part indicated by symbol AT5 in FIG. 11). However, the [rotation angle monitor value] at the time corresponding to the carrier period event CTE3 is 12, and the [position counter value] at the time corresponding to the carrier period event CTE5, two cycles later, is 12 (see the part indicated by symbol AT6 in FIG. 11). At one point, there is a timing where the [position counter value] deviates from the [rotation angle monitor value], but this deviation is subsequently resolved.

Thus, according to Embodiment 1, even if random modulation is applied to the carrier period event CTE to suppress switching loss, the disappearance of unprocessed steps among the step number SN can be avoided, and the rotational operation of the motor 5 is reproduced as information. As a result, an FB signal corresponding to the actual rotational angle position of the motor 5 is output, and the correct rotational angle information is transmitted to the controller 2. This allows controller 2 to accurately control the motor 5.

### Embodiment 2

The method for controlling the motor described above is also an embodiment of the present invention. That is, the motor control method according to Embodiment 2 of the present invention can be described as follows.

The motor control method according to Embodiment 2 includes generating and outputting a signal for controlling the motor 5 based on the instruction information CMF input from the controller 2 by the processor 31, generating and outputting the rotation amount information RF of the motor 5 based on the rotation angle information AF input from the motor 5 side, generating a carrier period event CTE of random modulation by the timer circuit 32, generating an FB signal FBS corresponding to the rotation angle of the motor 5 based on the rotation amount information RF of the motor 5 input from the processor 31 and the carrier period event CTE generated by the timer circuit 32 by the FB signal generation circuit 35, and outputting it to the controller 2. Furthermore, the FB signal generation circuit 35 generates and outputs the FB signal FBS by storing the next step number NSN corresponding to the rotation amount of the motor 5 between two temporally adjacent carrier period event CTE in the register 351, obtaining the first remaining step number RSN_1 by subtracting the number of steps that could be processed for generating the feedback signal FBS between the first carrier period event CTE_1 and the immediately following second carrier period event CTE_2 from the first next step number NSN_1 stored in the register 351 at the time the first carrier period event CTE_1 occurs by the remaining step number control circuit 357, obtaining the second total step number TSN_2 by adding the second next step number NSN_2 stored in the register 351 and the first remaining step number RSN_1 at the time the second carrier period event CTE_2 occurs by the total step number control circuit 358, and generating and outputting the FB signal FBS based on the second total step number TSN_2 by the output control circuit 356.

According to Embodiment 2, similar to Embodiment 1, even if random modulation is applied to the carrier period event CTE to suppress switching loss, the disappearance of unprocessed steps among the step number SN can be avoided, and the rotational operation of the motor 5 is reproduced as information. As a result, an FB signal corresponding to the actual rotational angle position of the motor 5 is output, and the correct rotational angle information is transmitted to the controller 2. This allows controller 2 to accurately control the motor 5.

While the invention made by the present inventor has been described based on the embodiments, the present invention is not limited to the above embodiments, and various modifications can be made without departing from the spirit of the present invention. For example, at least one part of the elements constituting semiconductor device 3 may be provided outside semiconductor device 3. In this case, the elements provided outside the semiconductor device 3 may be configured using other semiconductors or may be configured with circuits assembled discretely.

What is claimed is:

1. A semiconductor device comprising:
a processor that generates and outputs a signal for controlling a motor based on instruction information input from an external controller, and generates and outputs rotation amount information of the motor based on rotation angle information input from the motor side;
a timer circuit that generates a carrier period event of random modulation; and
a feedback signal generation circuit that generates a feedback signal corresponding to the rotation angle of the motor based on the rotation amount information of the motor input from the processor and the carrier period event generated by the timer circuit, and outputs it to the controller,
wherein the feedback signal generation circuit includes:
a register that stores the next step number corresponding to the rotation amount of the motor between two temporally adjacent carrier period event,
a remaining step number control circuit that obtains a first remaining step number by subtracting the number of steps that could be processed for generating the feedback signal between the first carrier period event and the second carrier period event immediately following it from the first next step number stored in the register at the time the first carrier period event occurs,
a total step number control circuit that obtains a second total step number by adding the second next step number stored in the register and the first remaining step number at the time the second carrier period event occurs, and
an output circuit that generates and outputs the feedback signal based on the second total step number.

2. The semiconductor device according to claim 1,
wherein the remaining step number control circuit obtains the first remaining step number when the number of steps that can be processed for generating the feedback signal within the first time is smaller than the first next step number, due to the first time between the first carrier period event and the second carrier period event being shorter than a reference carrier cycle.

3. The semiconductor device according to claim 2,
wherein the reference carrier cycle is a representative carrier cycle in the carrier period event of the random modulation.

4. The semiconductor device according to claim 3,
wherein the remaining step number control circuit captures the value of the first total step number immediately before the second total step number as an internal counter value in response to the occurrence of the first carrier period event, and obtains the first remaining step number by subtracting and updating the internal counter value by one each time an update timing is input.

5. The semiconductor device according to claim 4,
wherein the feedback signal generation circuit includes an update timing control circuit to which the second total step number is input from the total step number control circuit, and
wherein the update timing control circuit determines the time interval of the update timing based on the reference carrier cycle and the second total step number, and outputs the update timing to the remaining step number control circuit at the determined time interval.

6. The semiconductor device according to claim 5,
wherein the update timing control circuit determines the time interval of the update timing by dividing the reference carrier cycle by the second total step number.

7. The semiconductor device according to claim 5,
wherein the feedback signal generation circuit generates the feedback signal by updating a position counter value that reproduces the angular position of the motor in synchronization with the update timing.

8. The semiconductor device according to claim 1, further comprising:
a PWM generation circuit that generates a PWM signal based on the signal for controlling the motor and outputs it to the drive circuit of the motor.

9. The semiconductor device according to claim 1,
wherein the processor, the timer circuit, and the feedback signal generation circuit are formed on a semiconductor chip.

10. A motor control system comprising:
the semiconductor device according to claim 1, the controller, and the motor.

11. A motor control method comprising:
a processor that generates and outputs a signal for controlling a motor based on instruction information input from a controller, and generates and outputsg rotation amount information of the motor based on rotation angle information input from the motor side;
a timer circuit that generates random modulation carrier period event; and
a feedback signal generation circuit that generates a feedback signal corresponding to the motor's rotation angle based on the motor's rotation amount information input from the processor and the carrier period event generated by the timer circuit, and outputs it to the controller,
wherein the feedback signal generation circuit generates and outputs the feedback signal, including:
a register that stores the next step number corresponding to the rotation amount of the motor between two temporally adjacent carrier period events,
a remaining step number control circuit that obtains a first remaining step number by subtracting the number of steps that could be processed for generating the feedback signal between the first carrier period event and the second carrier period event immediately following it from the first next step number stored in the register at the time the first carrier period event occurs,
a total step number control circuit that obtains the second total step number by adding the second next step number stored in the register and the first remaining step number at the time the second carrier period event occurs, and
an output circuit that generates and outputs the feedback signal based on the second total step number.
